(19) United States
(12) Patent Application Publication
(10) Pub. No.: US 2005/0289352 A1
(43) Pub. Date: Dec. 29, 2005

(54) User authentification

(76) Inventor: Immo Benjes, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/531,011

(22) PCT Filed: Oct. 8, 2003
(86) PCT No.: PCT/IB03/04484

§ 371 Date: Apr. 12, 2005

(30) Foreign Application Priority Data
Oct. 16, 2002 (GB) 0224041.4

(51) Int. Cl. H04K 1/00

(52) U.S. Cl. 713/182

(57) ABSTRACT

In a method of verifying a user, a pass-sentence (Z₁, Z₂ . . . Z_{N}), comprising a string of word blocks which in sequence form a sentence known to the user, is associated with the user at step 12. At step 13, a pass number (Y₁, Y₂ . . . Y_{N}) comprising a string of numbers between 0 and 9 is associated with the user. At step 14, a table having N+1 columns and ten rows is generated. The first column is filled with digits 0 to 9 sequentially from top to bottom. The word blocks Z₁ to Z₈ are each included in the table thus: Zp is placed in column P+1 and in row Yp. The other cells in the table are then filled with suitable word blocks so that each column contains word blocks of the same type. A user knowing their pass-sentence and seeing the table then determines their passnumber by identifying the row number for which the first word block in their pass-sentence is found, and so on, and enters it at step 16. The input is compared at step 17 to the passnumber from step 13. If the numbers are the same, then step 18 determines that the user is valid.

This invention relates to a method of validating a user, and to a device and a system for implementing the method. This invention relates also to a software product, and to a computer readable medium.

When a designer determines how long a password or passnumber must be and what nature it must take in designing a system or device, a compromise needs to be made between the security conferred by the pass and the memorability of it. Short passes, such as the four-number passes commonly used with ATMs (automatic teller machines) do not confer a great deal of security (the number of possible combinations—including “0000”—is just 10,000). Longer passes, on the other hand, especially numeric passes, are easy to forget. Passwords are generally considered as easier to remember than passnumbers of the same length. However, passwords are not easily usable with numeric input devices such as telephone keypads and television or video player remote controls.

Systems which involve strings of words in user validation are disclosed in JP 09-114785, JP 2001-053739 and WO 00/57370. Other user authentication systems are disclosed in U.S. Pat. No. 6,035,406 and JP 07-336348.

It is an aim of the invention to provide a user validation system, device and method which achieves the security and inputability benefits found with numeric passes and the memorability benefits found with word-passed passes.

According to a first aspect of the invention, there is provided a method of validating a user, the method comprising associating a pass-sentence comprising a string of word blocks (Z₁, Z₂ . . . Z_{N}) with the user, associating a passnumber comprising a string of numeric characters (Y₁, Y₂ . . . Y_{N}) with the user, generating from the passnumber and the pass-sentence a table having columns in a vertical or horizontal direction and rows in the other direction, in which each word block of the pass-sentence (Zₚ) is located in a column dependent on the number of preceding word blocks (P−1) in the pass-sentence and in a row dependent on the corresponding character (Yₚ) in the pass-sentence, displaying the table, receiving an input comprising a string of numeric characters, comparing the input to the passnumber, and determining if the input is a valid input on the basis of the comparison.

The generating step may comprise recalling the table from a storage device. Preferably, though, the generating step comprises generating the table at random, allowing the passnumber to vary on each occasion of requiring the passnumber. Preferably word blocks for use in generating the table are stored in a storage device. More preferably the number of word blocks stored in the storage device is approximately equal to the number of word block spaces in the table. This can allow the table to vary on each occasion whilst using the same word blocks, so that the pass-sentence cannot be deduced by examining different tables and identifying word blocks common to the tables. Preferably, the table is filled with words such that each of the possible routes from one side to the opposite side produces a grammatically correct sentence. This may be achieved by filling the cells in each column with words of the same type, e.g. pronoun, adjective, past-participle, or with word strings of the same type.

The invention also comprises a software product comprising computer executable instructions for carrying out the above method, and computer readable media having stored therein such a software product.

The invention also provides a device arranged for implementing the above method, and a system arranged for implementing the method.

Embodiments of the invention will now be described, by way of example only, with reference to the accompanying drawings, of which:

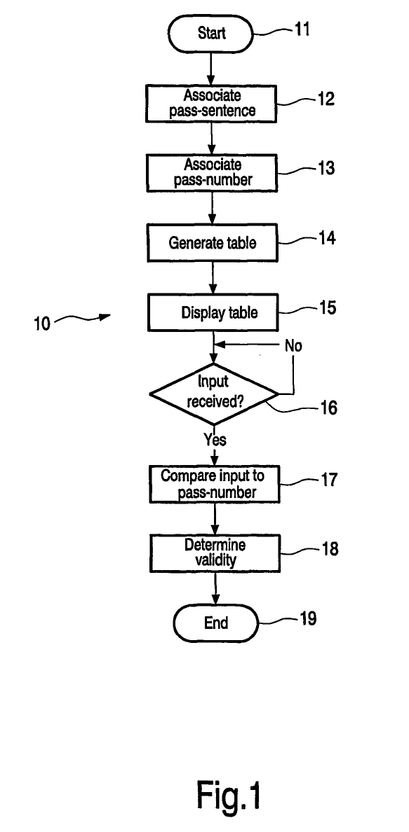

FIG. 1 is a flowchart illustrating a method according to one aspect of the invention;

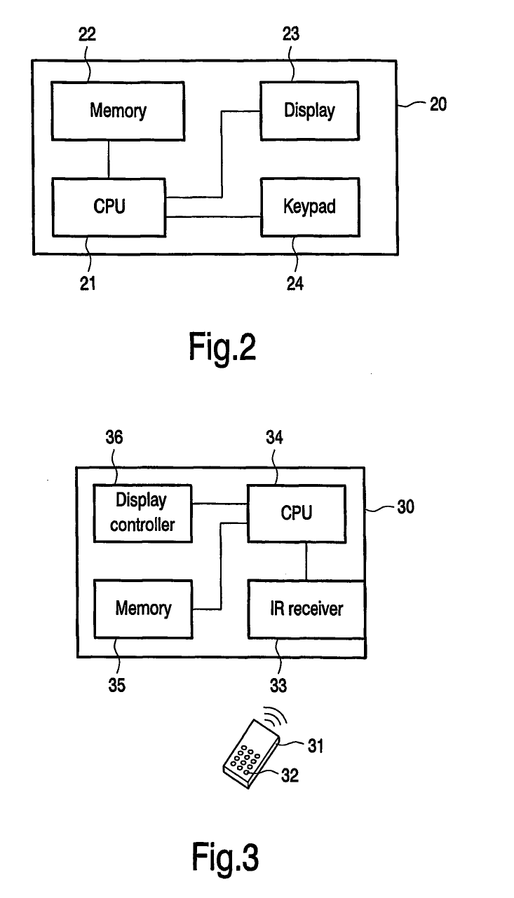

FIGS. 2 and 3 are schematic diagrams illustrating respective embodiments of devices according to one aspect of the invention.

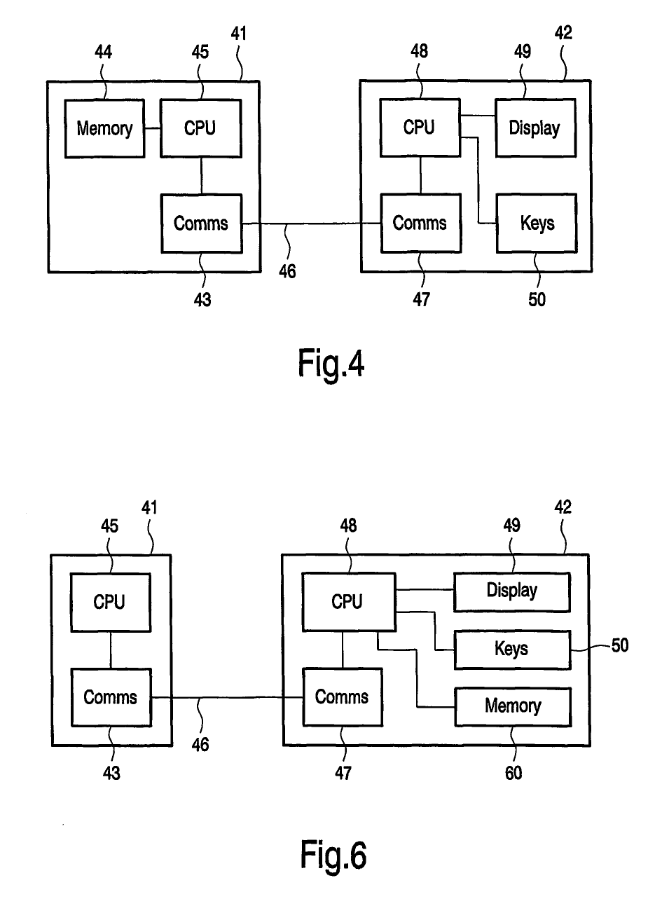

FIG. 4 is a schematic diagram of a system according to one aspect of the invention;

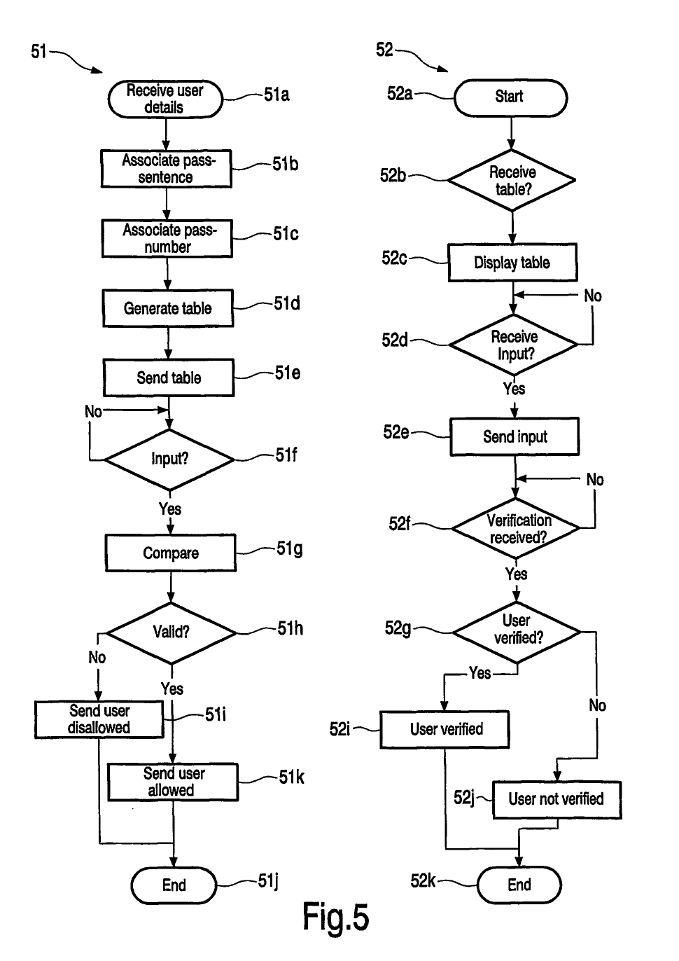

FIG. 5 is a flowchart illustrating operation of the components of the FIG. 4 system; and

FIG. 6 is a schematic diagram of a second embodied system, according to one aspect of the invention.

A method of verifying a user is now described with reference to FIG. 1. Referring to FIG. 1, the method 10 begins at step 11, after which a pass-sentence is associated with the user at step 12. This step involves the reading from an electronic memory a string of word blocks which in sequence form a sentence known to the user. In this example, the pass-sentence (Z₁, Z₂ . . . Z_{N}) comprises the following sequence (separate word blocks are included within brackets): (I) (walked) (to the) (zoo) (and) (saw) (a) (monkey). At step 13, a pass number (Y₁, Y₂ . . . Y_{N}) is associated with the user. The passnumber comprises a string of numbers between 0 and 9, the length of the string (the number of numbers) being equal to the number N of word blocks in the pass-sentence (here N=8). In this example, the passnumber is 64310972. At step 14, a table is generated. The table has N+1 columns, and ten rows. The first column is filled with digits 0 to 9 sequentially from top to bottom. The word blocks Z₁ to Z₈ are each included in the table at a position dictated by the value of the corresponding digit in the passnumber and the number of the word block in the pass-sentence. The relationship can be defined thus: Zp is placed in column P+1 and in row Yp. The other cells in the table are then filled with suitable word blocks so that each column contains word blocks of the same type, for example nouns, articles, past participles etc. This allows a number of sentences equal to 10^{N} to be readable from left to right across the table. Most of these sentences will be nonsensical, but each will be grammatically correct. At step 15, the table is displayed. An example is shown in table 1.

TABLE 1

| | | | | | | | | |
|---|---|---|---|---|---|---|---|---|
| 0 | Fred | ran | through the | car | and | threw | ones | tree |
| 1 | They | went | up the | zoo | then | slapped | the | shoe |
| 2 | Ma | sailed | across the | theatre | and | melted | its | monk |
| 3 | Rick | thought | to the | hill | then | breathed | their | bucket |
| 4 | She | walked | by the | box | but | froze | my | ticket |
| 5 | He | saw | around the | tourist | but | kicked | her | bike |
| 6 | I | talked | about the | bus | and | hung | mum's | duster |
| 7 | Pa | rode | against the | car | but | dribbled | a | mug |
| 8 | Rob | swarm | under the | TV | then | dropped | his | trolley |
| 9 | Peter | flew | into the | mallet | and | saw | dad's | face |

A user knowing their pass-sentence and seeing the table then determines their passnumber. This is done by finding the row in the second column in which the first word block in their pass-sentence is found, and tracing that to the first column to find the corresponding digit. This continues for each subsequent column until the passnumber is found. This is then entered, using a keypad for example. Of course, the user may enter each digit as it is determined from the table, to avoid having to remember N digits before entering the passnumber. The method 10 remains at step 16 until a passnumber is entered. On receiving an input, it is compared at step 17 to the passnumber from step 13. If the comparison step 17 determines that the numbers are the same, then step 18 determines that the user is valid. In this connection, it will be appreciated that where plural rows in a column contain the same word block, any of the digits corresponding to the correct word block is acceptable. Viewed differently, it might be considered that there are plural valid passnumbers, one for each combination of word blocks which in sequence form the pass-sentence. If the input is not the same as the passnumber, an invalid user determination is made at step 18. The method 10 ends at step 19.

Apparatus for implementing the method of FIG. 1 is shown in FIG. 2. Referring to FIG. 2, a mobile telephone is shown schematically at 20. It includes a CPU (central processing unit) 21, which is connected to each of a memory 22, a display 23 and a numeric keypad 24. Audio message handling means (not shown) including transceiver, microphone and speaker or earpiece will also be provided. The CPU 21 is loaded with software from the memory 22 suitable for controlling the CPU to carry out the steps 12-14 of FIG. 1. Here, there is no ‘user logon’ step. At step 15, the table is displayed on the display 23, following which an input is entered by a user using the keypad 24. The CPU 21 then carries out steps 17 and 18 of the method 10. The pass-sentence is preferably stored in the memory 22, for recalling by the CPU 21 at step 12. Alternatively, the pass-sentence may be received as an SMS message, for example.

Alternative apparatus is shown in FIG. 3. Here, a television 30 is operated by a user through a remote control 31, which sends infra red signals dependent on keys pressed on a keypad 32 including numbers 0 to 9. These signals are received at an infra red receiver 33, which is connected to a CPU 34 along with a memory 35 and a display control 36. Operation is the same as with the FIG. 2 embodiment, except that input is made by a user using the keypad 32 on the remote control 31.

A system implementing the FIG. 1 method is shown in FIG. 4. Referring to FIG. 4, the system 40 comprises a server computer 41 and a client computer 42. The server computer 41 includes a communications module 43 and a memory 44, each connected to a CPU 45.

At the other end of a secure link 46, a communications module 47 in the client 42 enables communication with the server 41. A CPU 48 is connected to the communications module 47, to a display 49 and to a keypad 50. The server computer 41 may be a banking computer and the client 42 an ATM, for example. Operation will now be described with reference to FIG. 5.

Referring to FIG. 5, a first operation 51 is run on the server 41, and a second operation 52 is run on the client 42. User details are received at the client 42 at step 52a, for example from a magnetic account card (not shown). The user details are sent at step 52b to the server 41, where they are received at step 51a. Meanwhile, the client 42 awaits input of a table at step 52b. The server 41 at step 51b retrieves a pass-sentence associated with the user from its memory 44, then generates a passnumber at step 51c, before generating a table at step 51d in the manner described above in relation to FIG. 1. The table is then sent at step 51e, following which the server 41 waits at step 51f for an input. When the client 42 receives the table, it displays it at step 52c, then awaits an input at step 52d. When an input is received, it is sent at step 52e to the server 41, following which the client 42 awaits a verification signal at step 52f. When an input is received at the server 41, it is compared to the passnumber at step 51g, and validity determined at step 51h. If the user is valid, a positive verification signal is sent at step 51k before the operation ends at step 51j. Otherwise, a negative verification signal is sent at step 51i, before ending at step 51j. At the client 42, the verification signal is examined at step 52g, and the user verified at step 52i or not verified at step 52j as appropriate before ending at step 52k.

An alternative system is shown in FIG. 6. Referring to FIG. 6, reference numerals are retained from FIG. 4 for like elements. Here, the pass-sentence is stored in a memory 60 in the client 42, and the server 41 has no knowledge of it. In this embodiment, the method of FIG. 1 is carried out entirely on the client 42, which the server 41 must accept as trustable. Once a user has been verified by the client 42, the user is given access to communicate with the server 41 via the client. Here, the client 42 may have knowledge of the pass-sentence because the user initially set up their account on that client, or because the pass-sentence is encrypted on a smart card read by the client, for example.

In the above embodiments, the table may, instead of being generated at random for each login, be generated by the simple reading of a table from memory. In this case, the table is the same for each login, which has the advantage that the passnumber is always the same. If the table is generated at random on each login, though, this has the advantage that the passnumber is different every time, which avoids security being compromised if a user is watched entering their input number string. Preferably, each time a table is generated at random, the same words are used, albeit in different locations. This feature prevents the pass-sentence being derivable from examination of plural tables, with a view to seeing what word blocks are common to the tables.

In an alternative embodiment, plural tables are stored in memory, and a table is selected, preferably at random, on user login.

From reading the present disclosure, other variations and modifications will be apparent to persons skilled in the art. Such variations and modifications may involve equivalent and other features which are already known in the art and which may be used instead of or in addition to features already described herein. Although claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any claim and whether or not it mitigates any or all of the same technical problems as does the present invention. The Applicants hereby give notice that new claims may be formulated to such features and/or combinations of such features during the prosecution of the present Application or of any further Application derived therefrom

1. A method of validating a user, the method comprising:
associating a pass-sentence comprising a string of word blocks (Z₁, Z₂ . . . Z_{N}) with the user (12);
associating a passnumber comprising a string of numeric characters (Y₁, Y₂ . . . Y_{N}) with the user (13);
generating (14) from the passnumber and the pass-sentence a table having columns in a vertical or horizontal direction and rows in the other direction, in which each word block of the pass-sentence (Zₚ) is located in a column dependent on the number of preceding word blocks (Zₚ) in the pass-sentence and in a row dependent on the corresponding character (Yₚ) in the pass-sentence;
displaying the table (15);
receiving an input comprising a string of numeric characters (16);
comparing the input to the passnumber (17); and
determining if the input is a valid (18) input on the basis of the comparison.

2. A method as claimed in claim 1, in which the generating step comprises recalling the table from a storage device.

3. A method as claimed in claim 1, in which the generating step comprises generating the table at random.

4. A method as claimed in claim 3, in which word blocks for use in generating the table are stored in a storage device.

5. A method as claimed in claim 4, in which the number of word blocks stored in the storage device is approximately equal to the number of word block spaces in the table.

6. A method as claimed in any preceding claim, in which the table is filled with words such that each of the possible routes from a first word-filled column to a last word-filled column produces a grammatically correct sentence.

7. A method as claimed in claim 6, in which cells in each column are filled with words or with word strings of the same type.

8. A software product comprising computer executable instructions for carrying out the method of any preceding claim.

9. Computer readable media having stored thereon a software product as claimed in claim 8.

10. A device arranged for implementing the method of any of claims 1 to 7.

11. A system arranged for implementing the method of any of claims 1 to 7.
